(19) United States
(12) Patent Application Publication
(10) Pub. No.: US 2026/0105544 A1
(43) Pub. Date: Apr. 16, 2026

(54) APPARATUS AND METHOD FOR SUPPORTING POWER TRADING

(71) Applicants: HYUNDAI MOTOR COMPANY, SEOUL (KR); KIA CORPORATION, SEOUL (KR)

(72) Inventor: Young Sik Kim, Hwaseong-si (KR)

(73) Assignees: HYUNDAI MOTOR COMPANY, SEOUL (KR); KIA CORPORATION, SEOUL (KR)

(21) Appl. No.: 19/330,187

(22) Filed: Sep. 16, 2025

(30) Foreign Application Priority Data
Oct. 16, 2024 (KR) 10-2024-0141141

(51) Int. Cl. G06Q 50/06; B60L 53/66; B60L 55/00; G06Q 30/04; G06Q 40/04; H02J 3/00; H02J 3/32

(52) U.S. Cl. CPC G06Q 50/06; B60L 53/665; B60L 55/00; G06Q 30/04; G06Q 40/04; H02J 3/001; H02J 3/0075; H02J 3/322

(57) ABSTRACT

The present disclosure relates to an apparatus and method for supporting power trading. The apparatus for supporting power trading includes one or more processors, and a memory configured to store one or more programs executed by the one or more processors, in which, when a power purchase request is received from a first user terminal, the processor processes one of public power and individual power to be supplied to a first charging target designated by the first user terminal through a microgrid.

### CROSS-REFERENCE TO RELATED APPLICATION(S)

This application claims priority to and the benefit of Korean Patent Application No. 10-2024-0141141, filed on Oct. 16, 2024, the disclosure of which is incorporated herein by reference in its entirety.

### TECHNICAL FIELD

The present disclosure relates to an apparatus and method for supporting power trading, and more particularly, to an apparatus and method for supporting power trading which are capable of trading solar energy or power charged in an electric vehicle in a microgrid or storing the solar energy or power in a public energy storage system (ESS).

### BACKGROUND

Some power grids have a one-way configuration that transmit power produced from a power plant to consumers. Recently, some consumers have acquired energy storage systems (ESSs), and prosumers, who play a role of directly producing power using solar energy and storing the produced power in an ESS, and even supplying the produced power, have emerged. However, in some power grids, consumers have (e.g., only) practiced self-sufficiency and have not participated in the entire power grid. In other words, most of the remaining power produced by consumers is not used and extinguished, resulting in low power efficiency.

Meanwhile, with the introduction of vehicle to grid (V2G) technology, technology that treats batteries of electric vehicles as ESSs and transmits power in both directions by linking with a power grid is receiving attention.

Therefore, it would be useful to have a technology to apply solar energy produced by consumers or power charged in electric vehicles to a microgrid to use the solar energy or power as alternative energy within the microgrid or link the solar energy or power to provide (e.g., enable) power trading to increase energy utilization.

### SUMMARY

The present disclosure is directed to providing an apparatus and method for supporting power trading which are capable of trading solar energy produced by consumers or power charged in electric vehicles in a microgrid or store the solar energy or power in a public energy storage system (ESS).

The present disclosure is not limited to the above-described objects, and other objects that are not mentioned may be understood by those having ordinary skill in the art to which the present disclosure pertains from the following description.

According to an aspect of the present disclosure, there is provided an apparatus for supporting power trading, including one or more processors, and a memory configured to store one or more programs executed by the one or more processors. When a power purchase request is received from a first user terminal, the processor processes one of public power and individual power to be supplied to a first charging target designated by the first user terminal through a microgrid.

The public power may be power stored in a public energy storage system (ESS) managed by the microgrid, and the individual power may be power stored in at least one of a second electric vehicle and/or a second individual ESS associated with a user of a second user terminal.

The processor may inform the first user terminal of a sales price of the public power sold in the microgrid and a sales price of main power sold in a main grid when the power purchase request is received, and process the public power stored in the public ESS to be supplied to the first charging target after billing processing when the first user terminal selects the public power.

The processor may process the public power to be supplied to a first electric vehicle through electric vehicle supply equipment (EVSE) and the microgrid when the first charging target is the first electric vehicle, and process the public power to be supplied to a first individual ESS through at least one of the microgrid and/or the main grid when the first charging target is the first individual ESS.

The processor may provide an individual power supplier list to the first user terminal based on an individual power purchase request of the first user terminal, and process individual power of a first individual power supplier to be supplied to the first charging target through at least one of EVSE, the microgrid, and/or the main grid when the first user terminal selects the first individual power supplier included in the individual power supplier list.

The power purchase request received from the first user terminal may be a request for charging at least one of a first electric vehicle and/or a first individual ESS associated with a user of the first user terminal.

When an emergency situation requesting (e.g., requiring) power supply to a second charging target occurs, the processor may process the individual power to be supplied to the second charging target through at least one of the microgrid and/or a main grid, the public power is power stored in a public ESS managed by the microgrid, and the individual power may be power stored in at least one of a third electric vehicle and/or a third individual ESS associated with one of a plurality of third user terminals.

When the emergency situation occurs, the processor may generate a message to induce a sale of the individual power and then process the generated message to be transmitted to the plurality of third user terminals.

The processor may inform the plurality of third user terminals of a purchase price when the microgrid purchases the individual power and a purchase price when the main grid purchases the individual power, process individual power stored in at least one of the third electric vehicle and/or the third individual ESS to be supplied to the public ESS after billing processing when an emergency power sale to the microgrid is accepted from one of the plurality of third user terminals, and process the individual power supplied to the public ESS to be urgently supplied to the second charging target.

The second charging target may include at least one of a fourth individual ESS associated with a user of a fourth user terminal and/or an external public ESS used in an external microgrid, and the processor may process the individual power to be supplied to the second charging target through at least one of EVSE, the microgrid, and/or the main grid.

The processor may provide an individual power consumer list to the plurality of third user terminals, and process the individual power stored in at least one of the third electric vehicle and/or the third individual ESS to be urgently supplied to an electric vehicle or an individual ESS of a first individual power consumer after billing processing when one of the plurality of third user terminals selects the first individual power consumer included in the individual power consumer list.

According to another aspect of the present disclosure, there is provided a method of supporting power trading, which includes receiving a power purchase request from a first user terminal, and processing one of public power and individual power to be supplied to a first charging target designated by the first user terminal through a microgrid.

The processing of one of the public power and/or the individual power to be supplied to the first charging target may include informing the first user terminal of a sales price of the public power sold in the microgrid and a sales price of main power sold in a main grid when the power purchase request is received, and processing the public power stored in the public ESS to be supplied to the first charging target after billing processing when the first user terminal selects the public power.

The processing of one of the public power and/or the individual power to be supplied to the first charging target may include processing the public power to be supplied to a first electric vehicle through EVSE and the microgrid when the first charging target is the first electric vehicle, and processing the public power to be supplied to a first individual ESS through at least one of the microgrid and/or the main grid when the first charging target is the first individual ESS.

The processing of one of the public power and the individual power to be supplied to the first charging target may include providing an individual power supplier list to the first user terminal based on an individual power purchase request of the first user terminal, and processing individual power of a first individual power supplier to be supplied to the first charging target through at least one of EVSE, the microgrid, and/or the main grid when the first user terminal selects the first individual power supplier included in the individual power supplier list.

The method may further include processing the individual power to be supplied to a second charging target through at least one of the microgrid/or and a main grid when an emergency situation requesting (e.g., requiring) power supply to the second charging target occurs, in which the public power may be power stored in a public ESS managed by the microgrid, and the individual power may be power stored in at least one of a third electric vehicle and/or a third individual ESS associated with one of a plurality of third user terminals.

The processing of the individual power to be supplied to the second charging target may include generating a message to induce a sale of the individual power and then processing the generated message to be transmitted to the plurality of third user terminals when the emergency situation occurs.

The processing of the individual power to be supplied to the second charging target may include: informing the plurality of second user terminals of a purchase price when the microgrid purchases the individual power and a purchase price when the main grid purchases the individual power, processing individual power stored in at least one of the third electric vehicle and/or the third individual ESS to be supplied to the public ESS after billing processing when an emergency power sale to the microgrid is accepted from one of the plurality of third user terminals, and processing the individual power supplied to the public ESS to be urgently supplied to the second charging target.

The second charging target may include at least one of a fourth individual ESS associated with a user of a fourth user terminal and/or an external public ESS used in an external microgrid, and the processing of the individual power to be supplied to the second charging target may include processing the individual power to be supplied to the second charging target through at least one of EVSE, the microgrid, and/or the main grid.

The processing of the individual power to be supplied to the second charging target may include providing an individual power consumer list to the plurality of third user terminals, and processing the individual power to be traded between one of the plurality of third user terminals and a first individual power consumer after the billing processing when one of the plurality of third user terminals selects the first individual power consumer included in the individual power consumer list.

### BRIEF DESCRIPTION OF DRAWINGS

The above and other objects and features of the present disclosure will become more apparent to those of ordinary skill in the art by describing exemplary embodiments thereof in detail with reference to the accompanying drawings, in which:

FIG. 1 is a diagram for describing an electric vehicle power management system according to an embodiment;

FIG. 2 is a diagram illustrating a power trading system according to an embodiment of the present disclosure;

FIG. 3 is a block diagram of a configuration of an apparatus for supporting power trading illustrated in FIG. 2;

FIG. 4 is a diagram illustrating a power trading system according to another embodiment of the present disclosure;

FIG. 5 is a diagram illustrating a power trading system according to still another embodiment of the present disclosure;

FIG. 6 is a flowchart illustrating a power trading method when a power purchase request is made according to an embodiment of the present disclosure;

FIG. 7 is a flowchart illustrating a power trading method when inducing a sale of individual power according to another embodiment of the present disclosure; and

FIG. 8 is a flowchart illustrating a power trading method when an individual power sale request is made according to another embodiment of the present disclosure.

### DETAILED DESCRIPTION

Hereinafter, embodiments of the present disclosure will be described in detail with reference to the accompanying drawings.

However, the present disclosure is not limited to the few embodiments that are described, but can be implemented in various different forms, and one or more of the components among the embodiments can be selectively combined or substituted for use within the scope of the technical idea of the present disclosure.

In addition, terms (including technical and scientific terms) used in the embodiment of the present disclosure can be interpreted as having meanings that can be generally understood by a person of ordinary skill in the technical field to which the present disclosure belongs, unless explicitly and specifically defined and described, and the terms that are commonly used, such as terms defined in a dictionary, can be interpreted in consideration of the contextual meaning of the related technology.

In addition, the terms used in the embodiments of the present disclosure are for describing embodiments rather than limiting the present disclosure.

In this specification, singular may also include plural unless specifically stated in the phrase, and when “at least one (or more) of A and (or) B and C” is described, it may include one or more of all combinations that may be combined with A, B, and C.

In addition, the terms “first,” “second,” “A,” “B,” “(a),” “(b),” and the like will be used in describing components of the example embodiment of the present disclosure.

These terms are used in order to distinguish any component from other components, and features, sequences, or the like, of the corresponding components are not limited by these terms.

In addition, when it is described that a component is “connected,” “coupled,” or “joined” to another component, it may include not only cases where the component is directly connected, coupled, or joined to other components, but also cases where the component is “connected,” “coupled,” or “joined” by another component between the component and other components.

Hereinafter, example embodiments will be described in detail with reference to the accompanying drawings. The same reference numerals will be used to describe the same or similar components throughout the drawings and overlapping description of the same components will be omitted.

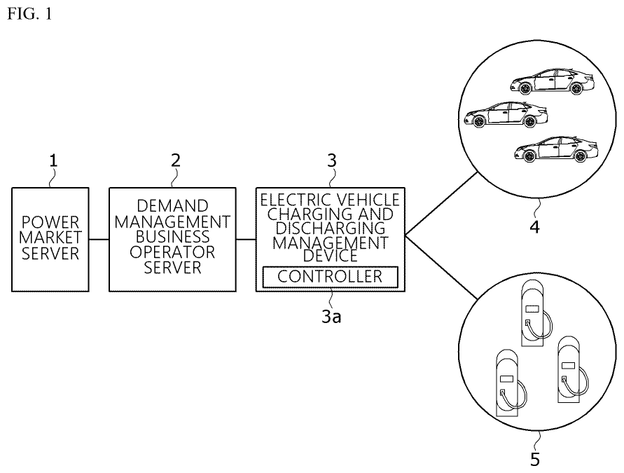

FIG. 1 is a diagram for describing an electric vehicle power management system according to an example embodiment. Referring to FIG. 1, the electric vehicle power management system may include a power market server 1, a demand management business operator server 2, and an electric vehicle charging and discharging management device 3.

The power market server 1 is a subject that operates a power market and may perform settlement according to a participation amount of each resource in different ways according to settlement rules of the power market. The power market server 1 may mediate power trading between a plurality of demand management business operator servers 2 using power trading request information received from the demand management business operator servers 2.

The power market server 1 may be a server that contracts with a demand management business operator to contract power usage and discharge business volume and distributes profits to a demand management business operator through demand response and power unit price by time zone.

The demand management business operator server 2 may perform power trading using charging and discharging information received from a linked electric vehicle charging and discharging management device 3, renewable energy generation amount information of a linked renewable energy generation system, and power demand information of a linked grid.

In an example embodiment, a demand management business operator may be a business operator who contracts with places that use large amounts of power, such as factories, large buildings, and parking towers, to perform power consumption reduction or the like according to demand response and thus gains profits.

A power grid linked to the demand management business operator may transmit power demand information to the demand management business operator server 2 at a preset cycle, at the request of the demand management business operator server, or when necessary. The power demand information may include hourly power demand and power usage reduction demand of the linked grid.

The demand management business operator server 2 may perform a role like a power plant that may not only respond to demand response through a power usage reduction request, but also reversely transmit power that may be used directly in a grid using an electric vehicle 4, an electric vehicle battery, an energy storage system (ESS), etc.

For example, the demand management business operator server 2 may receive a next day's charging and discharging amount of the electric vehicle charging and discharging management device 3 at a specific time every day and bid to a power market server side, and receive a successful bid amount from the power market server 1 according to a preset cycle and transmit the received successful bid to the electric vehicle charging and discharging management device 3.

The electric vehicle charging and discharging management device 3 may directly manage the electric vehicle 4, the charging station 5, etc., of customers participating in a V2X service, and receive information on the electric vehicle 4 and a charger, a plug-in/out signal, etc. The electric vehicle charging and discharging management device 3 may determine the next day's charging and discharging bid amount with the goal of maximizing market participation profits and control the charging and discharging of individual electric vehicles 4 to execute the successful bid amount.

The electric vehicle charging and discharging management device 3 may monitor the information of the electric vehicle 4 and the charging station 5 and provide various data for customers. The electric vehicle charging and discharging management device 3 may perform functions such as billing settlement, parking space management, generating and transmitting charging and discharging control commands, controlling charging and discharging scenarios, and diagnosing vehicle battery conditions.

The electric vehicle charging and discharging management device 3 may include a controller 3a.

The power grid may include, for example, smart grid-related systems such as a substation, a power market server, a demand management business operator server, renewable sources, or an energy storage system. The renewable sources may be energy sources utilizing wind power, solar power, geothermal heat, waste, etc. The power grid may supply power within the range of the allowable power (or maximum power) (Pmax) (or allowable AC current (IACmax)) to the charging station 5 by the control of the controller 3a.

In some cases, when a large number of electric vehicles 4 are concentrated at the charging stations 5 in a specific area at the same time, the maximum allowable power of the power grid may vary. That is, the power market server 1, the demand management business operator server 2, or an energy management system (EMS) that controls the grid operation may increase the power capacity by inputting a reserve power source such as an ESS or a nearby renewable source and supply the increased power to the charging stations.

The allowable power may be increased by the control of the controller 3a when the power supplied to the electric vehicle 4 is insufficient due to the charging demand information (charging demand of electric vehicle users) of each electric vehicle 4. That is, the controller 3a may control a switch to additionally connect (input) the renewable source (or energy storage system) within the power grid to the substation that supplies power to the charging stations 5 so that the allowable power of the power grid increases when the charging load (load of the electric vehicle) of the charging station 5 exceeds the allowable power of the power grid.

The controller 3a may control the overall operation of the components included in the electric vehicle charging and discharging management device 3. The controller 3a is an aggregator, and may collect the battery capacity of the electric vehicle 4 connected to the charging station 5 through a wired or wireless communication network, a state of charge (SoC) of the battery of the electric vehicle 4, a rated current flowing through the power line, a rated voltage applied to the power line, or the charging demand information of the electric vehicle user (e.g., the owner). The charging demand information of the electric vehicle user may be transmitted to the controller 3a through a communication means included in each of the charging stations 5, or transmitted to the controller 3a through a communication means, such as a user's mobile phone. For example, the communications means may be Ethernet, power line communication (PLC), Bluetooth, Wi-Fi, and/or the like.

The controller 3a may exchange information with the power grid through a wired/wireless communication network, and exchange data with the charging station 5 through a LAN connection such as Ethernet, power line communication (PLC), Bluetooth, or Wi-Fi, which is a wired/wireless communication network.

The controller 3a may control the power of the power grid to be supplied to the charging station 5 within the allowable power range of the power grid based on real-time information of the power grid, status information of the electric vehicle 4, and charging request information of each electric vehicle 4.

The real-time information of the power grid includes allowable power information of the power grid or power rate information of the power grid, the status information of the electric vehicle 4 includes SoC information of the battery included in each electric vehicle 4, and the charging request information may include a charging request time, an expected entry time, an expected exit time, and a charging request amount (target SoC) of the electric vehicle user.

The charging station 5 may charge batteries of the plurality of electric vehicles 4. Each of the charging stations 5 may include an AC current limiter that performs a current allocation operation for each of the electric vehicles 4. In addition, each of the charging stations 5 may include a control module that exchanges information with a battery management system (BMS) of the electric vehicles 4 and a controller 3a. Under the control of the controller 3a, the control module may control the current limiter (AC current limiter) to provide a DC charging current to each of the batteries of the electric vehicles 4.

Each of the electric vehicles 4 may include the BMS. The BMS may control a battery charging process. Each of the electric vehicles 4 may function as an active load that requests power from the electric vehicle charging and discharging management device 3 during the charging time.

The charger that converts AC of the power grid to DC to charge the batteries of the electric vehicles 4 may be an on-board charger included in each of the electric vehicles 4 or an off-board charger included in each of the charging stations 5.

The electric vehicle 4 may participate in power trading by registering on the V2X platform. The user of the electric vehicle 4 may join the platform according to the power market he/she wishes to participate in and register his/her expected entry and exit schedules for the next day. The electric vehicle 4 may transmit information, such as expected plug-in time, expected plug-out time, SoC information, and available battery capacity, to the electric vehicle charging and discharging management device 3.

The above-described electric vehicle power management system may be a centralized control system, and may adjust the charging and discharging schedules of electric vehicles by considering hourly power prices, demand and supply of a power grid, etc. However, as the number of electric vehicles to be controlled increases, the computation amount and complexity for optimal scheduling increase.

The electric vehicle charging and discharging management device 3 according to the embodiment may optimize the charging and discharging of such a large-scale electric vehicle fleet.

An apparatus 300 for supporting power trading according to the example embodiment may be included in the configuration of the demand management business operator server 2 or may be provided as a separate device. In the case where the apparatus 300 for supporting power trading is provided as a separate device, a separate wired or wireless communication means for communicating with electric vehicles, external servers, and terminals, etc., may be provided. The communication device (or means) provided in the power trading support apparatus 300 may include, for example, at least one LAN connection communication module such as Ethernet, power line communication (PLC), Bluetooth, Wi-Fi, and/or the like, which are wired/wireless communication networks.

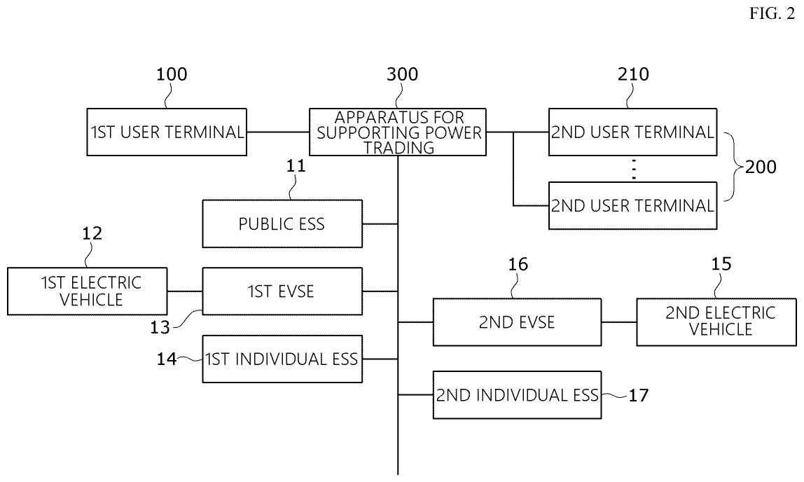

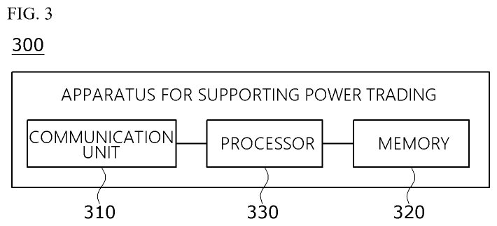

FIG. 2 is a diagram illustrating a power trading system according to an embodiment of the present disclosure, and FIG. 3 is a block diagram of the apparatus 300 for supporting power trading illustrated in FIG. 2.

The power trading system according to the embodiment of the present disclosure illustrated in FIG. 2 is intended to describe the power trading operation when a public power purchase request or an individual power purchase request is made.

The power trading system may supply power within a microgrid to other customers by utilizing vehicle to grid (V2G) or vehicle to home (V2H) technology and provide financial benefits and power grid stability.

The microgrid is a local power supply system centered on a distributed power source independent from the existing wide-area power grid and has a mutually complementary relationship with the wide-area power grid. All or part of the power trading system may be included in the microgrid. The microgrid may include at least one of the power market server 1, the demand management business operator server 2, the electric vehicle charging and discharging management device 3, photo voltaic (PV) energy, a public ESS, and an individual ESS.

The public ESS is a storage managed by the microgrid, and multiple users (i.e., a plurality of electric vehicles or a plurality of individual ESSs) belonging to the microgrid may purchase (i.e., charge) public power stored in the public ESS or store (i.e., sell or discharge) individual power in the public ESS.

The individual ESS is a storage managed individually by an individual and may store individual power or supply the stored individual power to another individual ESS or the public ESS. The individual power may be solar energy generated from a solar panel installed in a home or power supplied from the public ESS. The individual ESS may be installed in a home, a commercial building, a company, etc., and managed by an individual, and may be linked to a home EMS (HEMS). In such a case, the HEMS may be provided as an integrated system with PV energy, an ESS, an electric vehicle (EV), and electric vehicle supply equipment (EVSE).

Referring to FIG. 2, the power trading system according to the embodiment of the present disclosure may include a first user terminal 100, a plurality of second user terminals 200, and the apparatus 300 for supporting power trading.

A power trading app (e.g., application) may be installed and executed on the first user terminal 100 and the plurality of second user terminals 200. A user may sell individual power or purchase public power or other individual power while communicating with the apparatus 300 for supporting power trading using the power trading app.

The first user terminal 100 is a terminal device of a user using a first electric vehicle 12 or a first individual ESS 14. The first user terminal 100 may communicate with the apparatus 300 for supporting power trading to sell (i.e., discharge) individual power stored in the first electric vehicle 12 or the first individual ESS 14 or purchase (i.e., charge) individual power stored in the public ESS 11 or the second electric vehicle 15 or the second individual ESS 17. In the embodiment of the present disclosure, an operation of the first user terminal 100 purchasing the public power or the individual power is described.

The first user terminal 100 and the plurality of second user terminals 200 may be electronic devices capable of wired and wireless communication, such as a smart phone, a personal computer, a laptop, a wearable device, or a tablet. Hereinafter, a second user terminal 210 will be described as an example.

The second user terminal 210 is a terminal device of a user using a second electric vehicle 15 or a second individual ESS 17. The second user terminal 210 may communicate with the apparatus 300 for supporting power trading to sell the individual power stored in the second electric vehicle 15 or the second individual ESS 17 or purchase the individual power stored in the public ESS 11 or the first electric vehicle 12 or the first individual ESS 14. In the example embodiment of the present disclosure, for convenience of description, an operation of the second user terminal 210 selling the individual power is described.

The apparatus 300 for supporting power trading manages the charging and discharging of the common ESS 11 used in common in the microgrid and may mediate the power trading in the microgrid.

FIG. 3 is a block diagram illustrating the apparatus 300 for supporting power trading according to an embodiment of the present disclosure.

Referring to FIG. 3, the apparatus 300 for supporting power trading according to the embodiment of the present disclosure may include a communication unit 310, a memory 320, and a processor 330.

The apparatus 300 for supporting power trading according to the example embodiment may be implemented in a logic circuit by hardware, firmware, software, or a combination thereof, and may be implemented using a general-purpose or special-purpose computer. The apparatus may be implemented using a hardwired device, a field programmable gate array (FPGA), an application specific integrated circuit (ASIC), or the like. In addition, the apparatus 300 may be implemented as a system on chip (SoC) including one or more processors and controllers.

In addition, the apparatus 300 may be installed in a computing device or server equipped with hardware elements in the form of software, hardware, or a combination thereof. A computing device or server may be any of various devices including all or some of a communication device such as a communication modem for performing communication with various devices or wired/wireless communication networks, a memory for storing data for executing a program, a microprocessor for executing the program to perform calculations and commands, etc.

The apparatus 300 may be configured to provide a billing platform that facilitates transactions between the first user terminal 100 and the second user terminals 200.

The communication unit 310 is capable of wired/wireless communication with the first user terminal 100 and the plurality of second user terminals 200 through the network, and may transmit and receive various data, information, signals, etc. For example, the communication unit 310 may receive a signal indicating an intention to purchase the public power or the individual power from the first user terminal 100, receive an intention to sell the individual power from the second user terminal 210, and transmit a billing progress status or power transaction status to the first user terminal 100 and the second user terminal 210.

The memory 320 may be a storage medium (non-transitory storage medium) that stores instructions or a program including instructions executed by the processor 330. A memory 320 may include at least one of a storage medium such as a random access memory (RAM), a static RAM (SRAM), a read only memory (ROM), a programmable ROM (PROM), an erasable PROM (EPROM), an electrically EPROM (EEPROM), a hard disk drive (HDD), a solid state disk (SSD), an embedded multimedia card (eMMC), a universal flash storage (UFS), and/or a web storage. In addition, the memory 320 may include a database (DB).

The processor 330 may include at least one of processing devices such as an ASIC, a digital signal processor (DSP), programmable logic devices (PLDs), FPGAs, a central processing unit (CPU), microcontrollers, and/or microprocessors.

When the power purchase request is received from the first user terminal 100, the processor 330 may process one of the public power and the individual power to be supplied to the first charging target designated by the first user terminal 100 through the microgrid. The power purchase request is a power demand request indicating a desire to charge at least one of the first electric vehicle 12 and the first individual ESS 14, and the first charging target and the charging amount may be selected through the power transaction app of the first user terminal 100. The first charging target may be the first electric vehicle 12 or the first individual ESS 14 managed by the user of the first user terminal 100.

Here, the public power is power stored in the public ESS 11 managed in the microgrid, and the individual power is power to be purchased and therefore may be power stored in at least one of the second electric vehicle 15 and the second individual ESS 17, for example.

When the power purchase request is received from the first user terminal 100, the processor 330 may provide a first rate table to the first user terminal 100. The first rate table may include at least one of a sales price (i.e., a sales price of the public power stored in the public ESS 11) of the public power sold in the microgrid, a sales price of main power sold in the main grid, and an individual power rate.

The main grid is a wide-area power grid (for example, a power grid managed by the Korea Electric Power Corporation) and may be a main power grid, a central power grid, or a national power grid.

The individual power rate is a rate suggested by the plurality of second user terminals 200 who wish to sell individual power. Accordingly, the processor 330 may request the first user terminal 100 to select whether to use the public ESS 11, that is, to purchase the public power stored in the public ESS 11.

When the first user terminal 100 selects the purchase of the main power, after the billing processing, the processor 330 may process the first charging target to be charged through the power grid of the main grid with a server (not illustrated) that manages the main grid.

When the first user terminal 100 selects to purchase public power, that is, when the first user terminal 100 decides to purchase the public power stored in the public ESS 11, the processor 330 may process the public power stored in the public ESS 11 to be supplied to the first charging target after the billing processing.

When the first charging target is the first electric vehicle 12, the processor 330 may process the public power stored in the public ESS 11 to be supplied to the first electric vehicle 12 through the first EVSE 13 and the microgrid. The first EVSE 13 may be a charger to which the first electric vehicle 12 is connected for charging.

In addition, when the first charging target is the first individual ESS 14, the processor 330 may process the public power being supplied to the first individual ESS 14 through at least one of the microgrid and the main grid.

Meanwhile, when the first user terminal 100 requests the individual power purchase, the processor 330 may provide an individual power supplier list (hereinafter referred to as the “first list”) to the first user terminal 100.

For example, when the individual power purchase request is received, the processor 330 may transmit a bid notice to the plurality of second user terminals 200 and may receive information (e.g., necessary) for bidding from the second user terminals 200 that have expressed their intention to participate in the bidding. The processor 330 may collect information (e.g., necessary) for bidding, generate a first list, and then provide the first list to the first user terminal 100. The information requested (e.g., required) for bidding may include a sales price of the individual power presented by the second user terminals 200, the first discharging target, the amount of power available for sale, and the time available for discharge. The first discharging target is a storage where the individual power to be sold is stored and may be the second electric vehicle 15 or the second individual ESS 17.

When the first user terminal 100 selects a first individual power provider (for example, the user of the second user terminal 210) included in the first list, the processor 330 may process a contract between the first user terminal 100 and the second user terminal 210 to be concluded, and process the individual power of the first individual power provider to be supplied to the first charging target through at least one of the EVSE, the microgrid, and the main grid. The processor 330 may perform an authentication procedure during the contract conclusion process, and may use, for example, a MAC address or authentication app of the first electric vehicle 12 or the second electric vehicle 15 to enable individual trading to be made after authentication.

For example, when the first charging target is the first electric vehicle 12 and the first discharging target is the second electric vehicle 15, the processor 330 may process the individual power stored in the second electric vehicle 15 to be supplied to the first electric vehicle 12 through at least one of the second EVSE 16, the microgrid, the main grid, and the first EVSE 13. The second EVSE 16 may be a charger to which the second electric vehicle 15 is connected for V2G.

For example, when the first charging target is the first electric vehicle 12 and the first discharging target is the second individual ESS 17, the processor 330 may process the individual power stored in the second individual ESS 17 to be supplied to the first electric vehicle 12 through at least one of the microgrid, the main grid, and the first EVSE 13.

For example, when the first charging target is the first individual ESS 14 and the first discharging target is the second electric vehicle 15, the processor 330 may process the individual power stored in the second electric vehicle 15 to be supplied to the first individual ESS 14 through at least one of the second EVSE 16, the microgrid, and the main grid.

For example, when the first charging target is the first individual ESS 14 and the first discharging target is the second individual ESS 17, the processor 330 may process the individual power stored in the second individual ESS 17 to be supplied to the first individual ESS 14 through at least one of the microgrid and the main grid.

According to the above-described example embodiment, the first user terminal 100 may compare the power rate of the public ESS 11 or the main power grid to determine whether to use the public ESS 11. Alternatively, the first user terminal 100 may search for a low rate through bidding with power suppliers (i.e., users who have subscribed to a service selling individual power, such as users of the second user terminals 200) located in the microgrid to purchase individual power. When the contract with the power supplier fails, the first user terminal 100 may purchase power again from the public ESS 11 or the main power grid.

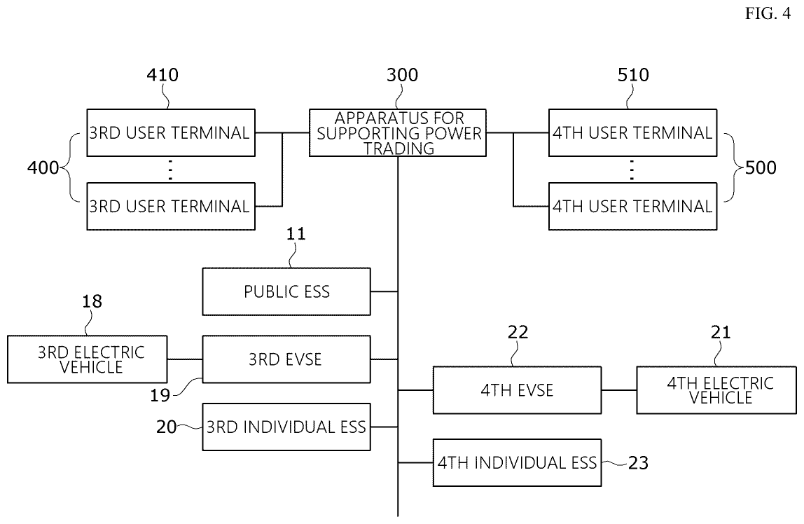

FIG. 4 is a diagram illustrating a power trading system according to another embodiment of the present disclosure.

The system illustrated in FIG. 4 is intended to describe the power trading operation when inducing the individual power to be sold. Referring to FIG. 4, the power trading system according to another example embodiment of the present disclosure may include a plurality of third user terminals 400, a plurality of fourth user terminals 500, and the apparatus 300 for supporting power trading.

The power trading app may be installed and executed on the plurality of third and fourth user terminals 400 and 500.

The plurality of third user terminals 400 may be terminals of users who have agreed to sell (e.g., emergency) power using the power trading app, or terminals of all users on which the power trading app is installed.

The plurality of fourth user terminals 500 may be terminals of users whose emergency power demand has occurred. The emergency power demand may occur when a power outage has occurred or is predicted, or when the stored public power, main power, or individual power is about to be exhausted.

The third electric vehicle 18 may be an electric vehicle of one of the plurality of third user terminals 400, and a third individual ESS 20 may be the individual ESS installed in the home of one of the users. The third electric vehicle 18 and the third individual ESS 20 are devices that store surplus power that can be sold, and may be second discharging targets.

The fourth electric vehicle 21 may be an electric vehicle of one of the plurality of fourth user terminals 500, and the fourth individual ESS 23 may be the individual ESS installed in the home of one of the users. The fourth electric vehicle 21 and the fourth individual ESS 23 are devices that do not have stored power or whose power will be exhausted soon, and may be a second charging target.

The second charging target that requests (e.g., requires) emergency power may be located within the same microgrid as the apparatus 300 for supporting power trading or located in an external microgrid. In this case, the second charging target may be an external public ESS (not illustrated) located in an external microgrid, or an external individual ESS (not illustrated).

The processor 330 of the apparatus 300 for supporting power trading may process the individual power stored in the second discharging target to be supplied to the second charging target through at least one of the microgrid and the main grid when an emergency situation occurs.

The emergency situation may occur when the above-described emergency power demand occurs, alternative energy is expected to be insufficient due to weather, or a power rate is set at a high price compared to a reference value. For example, the processor 330 may determine that the emergency situation has occurred when it receives information from the controller of the main grid (not illustrated) that a power outage has occurred. In addition, the processor 330 may determine that the power rate is set at a high price when it is higher than the same time zone of the previous day by a preset rate or more.

The public power may be power stored in the public ESS 11 managed in the microgrid, and the individual power may be power stored in at least one of the third electric vehicle 18 and the third individual ESS 20.

When the emergency situation occurs, the processor 330 may generate a message that induces the individual power to be discharged and the individual power to be stored in or sold to the public ESS 11, and then process the individual power to be transmitted to the plurality of third user terminals 400.

The processor 330 may provide the second rate table to the plurality of third user terminals 400 to determine whether to sell the individual power to the microgrid. The second rate table may include a purchase price when the microgrid purchases the individual power (i.e., a purchase price currently set in the apparatus 300 for supporting power trading) and a purchase price when the main grid purchases the individual power.

When the processor 330 receives an intention (i.e., accepts emergency power sale) to discharge or sell the individual power to the microgrid from any one of the plurality of third user terminals 400, after the authentication or billing processing, the processor 330 may process the individual power stored in at least one of the third electric vehicle 18 and the third individual ESS 20 to be supplied to the public ESS 11.

For example, when the discharge intention is received from a third user terminal 410, after the authentication processing, the processor 330 processes the individual power stored in at least one of the third electric vehicle 18 and the third individual ESS 20 to be stored in the public ESS 11. Thereafter, the processor 330 may process the individual power pre-stored in the public ESS 11 to be supplied to at least one of the third electric vehicle 18 and the third individual ESS 20 based on the request from the third user terminal 410.

Thereafter, the processor 330 may process the individual power supplied to the public ESS 11 to be supplied to the second charging target. Accordingly, the processor 330 may process the individual power to be urgently supplied to the second charging target through at least one of the third EVSE 19, the microgrid, the main grid, and the fourth EVSE 22.

For example, when the second charging target is the external public ESS (not illustrated), the processor 330 may process power to be supplied from the public ESS 11 to the external public ESS (not illustrated) through at least one of the microgrid and the main grid.

Alternatively, when the second charging target is the individual ESS, and the public ESS 11 and the second charging target are located in different microgrids, or there is an external public ESS (not illustrated) closer to the second charging target than the public ESS 11, the processor 330 may process power to be supplied from the external public ESS (not illustrated) to the second charging target.

Meanwhile, when the third user terminal 410 requests an individual consumer sale, i.e., transmits an intention to sell power to an individual, the processor 330 provides the individual power consumer list (hereinafter referred to as the “second list”), and when the third user terminal 410 selects a second individual power consumer (e.g., a user of the fourth user terminal 510) included in the second list, after the billing processing, the processor 330 may process the individual power to be traded between the third user terminal 410 and the second individual power consumer. The second list is a list showing users who are willing to purchase the individual power and may include information (e.g., required) for bidding.

For example, when the processor 330 receives an individual consumer sale request, the processor 330 may transmit a bidding notice to the plurality of fourth user terminals 500 and receive bidding information from the fourth user terminals 500 that have expressed their intention to participate in the bidding. The processor 330 may collect the bidding information to generate a second list and then provide the second list to the third user terminal 410. The bidding information may include a purchase price for the individual power presented by the fourth user terminals 500, a second charging target, an amount of power available for purchase, and a charging time. The second charging target is a device that will charge the purchased individual power and may be the fourth electric vehicle 21 or the fourth individual ESS 23. When the user of the third user terminal 410 does not wish to bid, the user may first present a desired selling price to the fourth user terminals 500.

When the third user terminal 410 selects the first individual power consumer (i.e., the user of the fourth user terminal 510) included in the second list, the processor 330 may process a contract to be concluded between the third user terminal 410 and the fourth user terminal 510, and process the individual power to be supplied from the third discharging target 18 or 20 to the fourth charging target 21 or 23 through at least one of the EVSE, the microgrid, and the main grid. The processor 330 may perform an authentication procedure during the contract conclusion process, and use, for example, a MAC address or authentication app of the third electric vehicle 18 or the fourth electric vehicle 21 to enable individual trading to be made after the authentication.

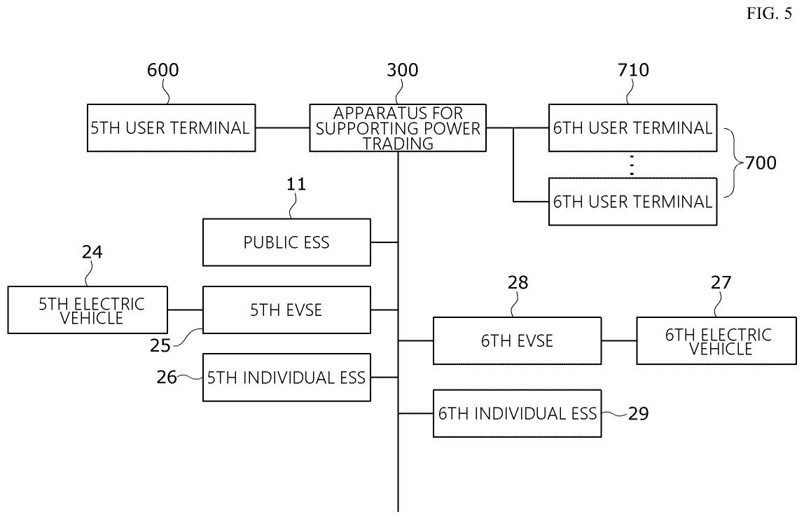

FIG. 5 is a diagram illustrating a power trading system according to another embodiment of the present disclosure.

The system illustrated in FIG. 5 is intended to describe a power trading operation when the individual power sale request is made. Referring to FIG. 5, the power trading system according to another embodiment of the present disclosure may include a fifth user terminal 600, a plurality of sixth user terminals 700, and the apparatus 300 for supporting power trading. The operation or configuration of the fifth user terminal 600, the plurality of sixth user terminals 700, and the apparatus 300 for supporting power trading is almost the same as the plurality of third user terminals 400, the plurality of fourth user terminals 500, and the apparatus 300 for supporting power trading described with reference to FIG. 4, and therefore a detailed description thereof will be omitted.

The power trading app may be installed and executed on the plurality of fifth and sixth user terminals 600 and 700.

The fifth electric vehicle 24 may be an electric vehicle of the user of the fifth user terminal 600, and the fifth individual ESS 26 may be an individual ESS equipped in the home of the user of the fifth user terminal 600. The fifth electric vehicle 24 and the fifth individual ESS 26 are devices that store surplus power that can be sold and may be third discharging targets.

The sixth electric vehicle 27 may be an electric vehicle of the user of the fourth user terminal 510, and the sixth individual ESS 29 may be an individual ESS equipped in the home of the user of the fourth user terminal 510. The sixth electric vehicle 27 and the sixth individual ESS 29 may be third charging targets for charging power.

The user of the fifth user terminal 600 may confirm the SoC of the fifth electric vehicle 24 or the fifth individual ESS 26 displayed on the power trading app, and when it is determined that surplus power has been generated, may transmit a power sale request to the apparatus 300 for supporting power trading. The power sale request may include information requesting the sale of surplus power and identification information of the third discharging target.

Alternatively, the fifth user terminal 600 may apply for a surplus power notification service in advance using the power trading app. In this case, the fifth electric vehicle 24 or the fifth individual ESS 26 may periodically transmit the SoC to the power trading app of the fifth user terminal 600, and the fifth user terminal 600 may transmit the received SoC to the apparatus 300 for supporting power trading. The processor 330 may determine whether the surplus power of the fifth electric vehicle 24 or the fifth individual ESS 26 has occurred from the received SoC and transmit a message to the fifth user terminal 600 to notify of the occurrence of surplus power and determine whether to sell the surplus power. The processor 330 may calculate the discharge amount of the third discharging target in advance by considering the confirmed SoC and then inform the fifth user terminal 600 of the calculated discharge amount by including the calculated discharge amount in the message. For example, when the power sales price is adjusted upward from before, the processor 330 may transmit the message to the fifth user terminal 600 with surplus power.

When the power sale request is received from the fifth user terminal 600, the processor 330 may process the individual power stored in the third discharging target to be supplied to the third charging target through at least one of the microgrid and the main grid.

The public power may be power stored in the public ESS 11 managed in the microgrid, and the individual power may be power stored in at least one of the fifth electric vehicle 24 or the fifth individual ESS 26.

When a power sales request is received, the processor 330 may guide the second rate table to the fifth user terminal 600 to determine whether to sell personal power to the microgrid.

When the processor 330 receives an intention to sell to the microgrid from the fifth user terminal 600, after the billing processing, the processor 330 may process the individual power stored in at least one of the fifth electric vehicle 24 and the fifth individual ESS 26 to be supplied to the public ESS 11. The processor 330 may process the individual power to be supplied to the public ESS 11 through the fifth EVSE 25 and the microgrid.

In addition, when the fifth user terminal 600 requests the individual consumer sale, that is, when the fifth user terminal 600 transmits an intention to sell power to an individual, the processor 330 may provide the individual power consumer list (hereinafter referred to as the “third list”) to the fifth user terminal 600. When the fifth user terminal 600 selects a third individual power consumer (e.g., a sixth user terminal 710) included in the third list, after the billing processing, the processor 330 may process the individual power to be traded between the fifth user terminal 600 and the third individual power consumer. Accordingly, the processor 330 may process the individual power to be supplied to the third charging target through at least one of the fifth EVSE 25 and the microgrid, the main grid, and the sixth EVSE 28.

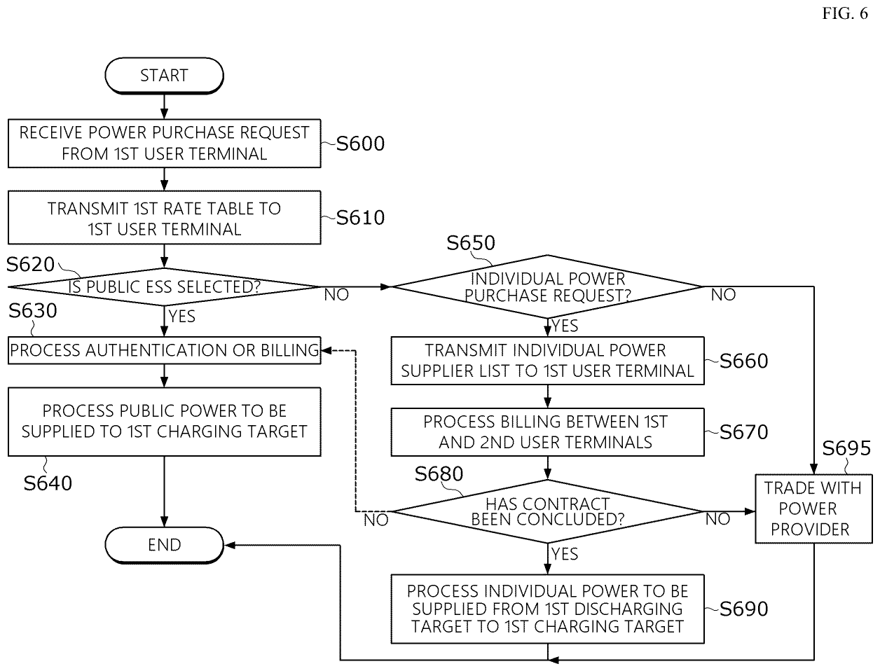

Hereinafter, a method of supporting power trading according to an example embodiment of the present disclosure will be described with reference to FIGS. 6 to 8. A computing device for performing the method of supporting power trading illustrated in FIGS. 6 to 8 may be the apparatus 300 for supporting power trading or the processor 330 described with reference to FIGS. 1 to 5.

FIG. 6 is a flowchart illustrating a power trading method when a power purchase request is made according to an embodiment of the present disclosure.

Referring to FIG. 6, when the power purchase request is received from the first user terminal 100 (S600), the computing device may transmit a first rate table to the first user terminal 100 (S610). The first rate table may include a sales price of public power sold in the microgrid, a sales price of main power sold in the main grid, and an individual power rate. The first rate table may be updated in response to changes in sales price and stored in the memory 320.

When the first user terminal 100 selects the purchase of the main power, after the billing processing, the processor 330 may process the first charging target to be charged through the power grid of the main grid with the server (not illustrated) that manages the main grid.

When the first user terminal 100 selects the purchase of the public power, that is, when the public ESS 11 is selected (S620-Yes), after authentication or billing processing (S630), the computing device may process the public power stored in the public ESS 11 to be supplied to the first charging target (the first electric vehicle 12 or the first individual ESS 14) (S640).

In addition, when the individual power purchase request is received from the first user terminal 100 after operation S620 (S650-Yes), the computing device may generate the individual power supplier list and transmit the generated individual power supplier list to the first user terminal 100 (S660). Operation S660 may transmit a bid notice to the plurality of second user terminals 200, receive information (e.g., necessary) for bidding from the second user terminals 200 that have expressed their intention to participate in the bid, and then collect the information to generate the individual power provider list.

When the first user terminal 100 selects the first individual power provider (e.g., the user of the second user terminal 210) from the individual power provider list, the computing device processes the contract between the first user terminal 100 and the second user terminal 210 (S670).

When the contract is concluded (S680-Yes), the computing device may process the individual power of the first individual power provider to be supplied from the first discharging target to the first charging target (S690).

On the other hand, when there is no individual power purchase request in operation S650 (S650-No), that is, when a power provider is selected, the computing device may process the power trading between the power provider and the first user terminal 100 (S695). The power provider may be the main grid.

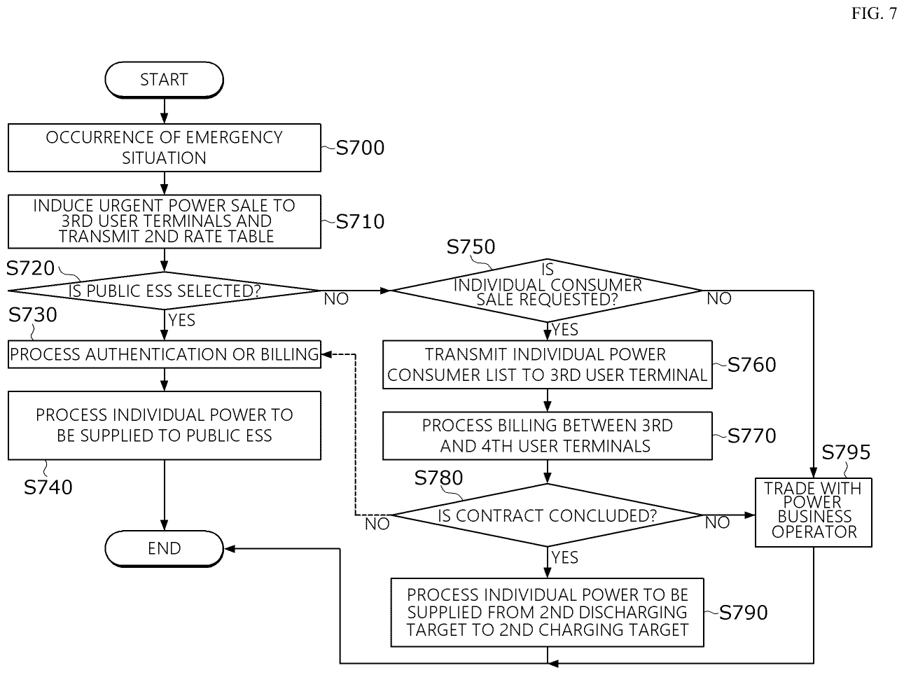

FIG. 7 is a flowchart illustrating the power trading method when inducing the sale of the individual power according to another embodiment of the present disclosure.

Referring to FIG. 7, when the emergency situation occurs (S700), the computing device may generate the message to induce the sale of the individual power and then transmit the message to the plurality of third user terminals 400 (S710).

When the public ESS 11 is selected from the third user terminals 410 (S720-Yes), after the authentication or billing processing (S730), the computing device may process the individual power stored in the second discharging target (the third electric vehicle 18 or the third individual ESS 20) to be supplied to the public ESS 11 (S740). Thereafter, the computing device may process the individual power supplied to the public ESS 11 to be supplied to the second charging target.

On the other hand, when the third user terminal 410 requests the individual consumer sale (S750-Yes), the computing device transmits the individual power consumer list (S760). In operation S760, the bidding notice may be transmitted to the fourth user terminals 500, the information (e.g., necessary) for bidding may be received from the fourth user terminals 500 that have expressed their intention to participate in the bidding, and then the information may be collected to generate the individual power consumer list.

When the third user terminal 410 selects the second individual power consumer (for example, the user of the fourth user terminal 510) included in the individual power consumer list, the computing device processes the billing processing and contract conclusion between the third user terminal 410 and the fourth user terminal 510 (S770).

When the contract is concluded (S780-Yes), the computing device may process the individual power of the second individual power supplier to be supplied from the second discharging target to the second charging target (S790).

On the other hand, when there is no individual consumer sale request in operation S750 (S750-No), i.e., when the power provider is selected, the computing device may process the power trading between the power provider and the third user terminal 410 (S795). Accordingly, the individual power may be supplied to the main grid from the second discharging target (the third electric vehicle 18 or the third individual ESS 20) managed by the user of the third user terminal 410.

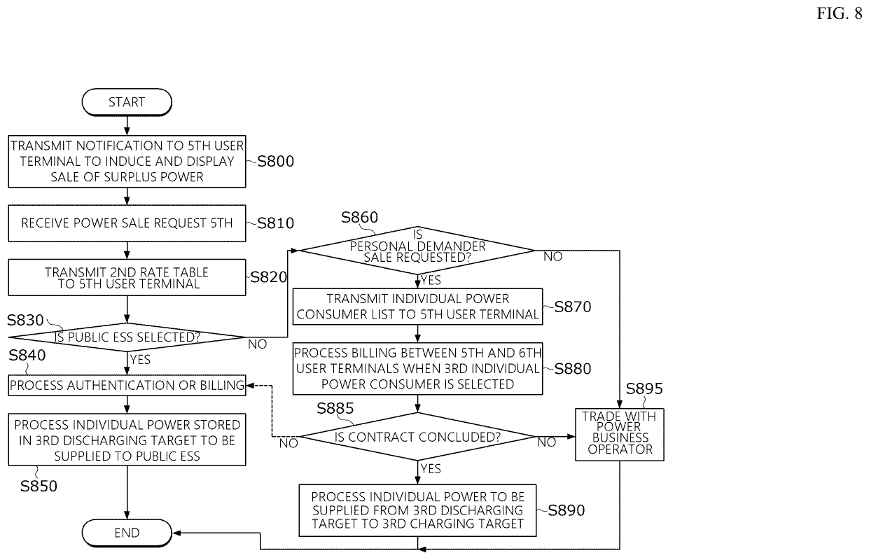

FIG. 8 is a flowchart illustrating the power trading method when the individual power sale request is made according to another embodiment of the present disclosure.

Referring to FIG. 8, the computing device transmits the notification to the fifth user terminal 600 to induce and display the sale of the surplus individual power (hereinafter referred to as “surplus power”) (S800).

When the intention to sell surplus power is received from the fifth user terminal 600, i.e., when the power sale request is received (S810), the computing device transmits the second rate table to the fifth user terminal 600 to inquire whether to sell to the public ESS 11 (S820).

When the public ESS 11 is selected (S830-Yes), i.e., when the intention to sell surplus power to the microgrid is received, after authentication or billing processing (S840), the computing device may process the surplus power stored in the third discharging target (the fifth electric vehicle 24 or the fifth individual ESS 26) to be supplied to the public ESS 11 (S850).

On the other hand, when the fifth user terminal 600 requests the individual consumer sale (S860-Yes), the computing device transmits the individual power consumer list (S870). In operation S870, the bidding notice may be transmitted to the sixth user terminals 700, the information necessary for bidding may be received from the sixth user terminals 700 that have expressed their intention to participate in the bidding, and then the information may be collected to generate the individual power consumer list.

When the fifth user terminal 600 selects the third individual power consumer (e.g., the user of the sixth user terminal 710) included in the individual power consumer list, the computing device processes the billing processing and contract conclusion between the fifth user terminal 600 and the sixth user terminal 710 (S880).

When the contract is concluded (S885-Yes), the computing device may process the individual power of the third individual power supplier to be supplied from the third discharging target to the third charging target (S890).

On the other hand, when there is no individual consumer sale request in operation S860 (S860-No), i.e., when the power provider is selected, the computing device may process the power trading between the power provider and the fifth user terminal 600 (S895). Accordingly, the individual power may be supplied to the main grid from the third discharging target managed by the user of the fifth user terminal 600.

The term “unit” used in the present embodiment refers to software or a hardware component such as an FPGA or an ASIC, and a “unit” plays a certain role. However, “unit” is not limited to software or hardware. A “unit” may be configured to be stored in a storage medium that can be addressed or may be configured to regenerate one or more processors. Accordingly, as an example, “unit” refers to components such as software components, object-oriented software components, class components, and task components, processes, functions, attributes, procedures, subroutines, segments of program code, drivers, firmware, microcode, circuits, data, databases, data structures, tables, arrays and variables. Components and functions provided within a “unit” may be combined into a smaller number of components and “units” or may be further separated into additional components and “units.” Furthermore, components and “units” may be implemented to reproduce one or more CPUs in a device or a security multimedia card.

According to the present disclosure, by trading the solar energy produced by the consumers or the power charged in the electric vehicles between individuals in the microgrid, trading the solar energy or power between individuals and the microgrid, or storing the surplus power in the public ESS, it is possible to create the monetary profits and stabilize the power grid.

The present disclosure is not limited to the above-described description. That is, other objects that are not described may be understood by those skilled in the art to which the present disclosure pertains from the following description.

Although exemplary embodiments of the present disclosure have been disclosed above, it may be understood by those skilled in the art that the present disclosure may be variously modified and changed without departing from the scope and spirit of the present disclosure described in the following claims.

What is claimed is:

1. An apparatus for supporting power trading, comprising:
a memory storing computer-executable instructions; and
at least one processor configured to access the memory and execute the instructions, wherein the instructions comprise:
when a power purchase request is received from a first user terminal, supplying at least one of public power or individual power to a first charging target designated by the first user terminal through a microgrid.

2. The apparatus of claim 1, wherein the public power is power stored in a public energy storage system (ESS) managed by the microgrid, and
the individual power is power stored in at least one of a second electric vehicle or a second individual ESS associated with a user of a second user terminal.

3. The apparatus of claim 2, wherein the instructions of the processor further comprise:
informing the first user terminal of a sales price of the public power sold in the microgrid and a sales price of main power sold in a main grid when the power purchase request is received;
supplying the public power stored in the public ESS to the first charging target after billing processing when the first user terminal selects the public power;
supplying the public power to a first electric vehicle through electric vehicle supply equipment (EVSE) and the microgrid when the first charging target is the first electric vehicle; and
supplying the public power to a first individual ESS through at least one of the microgrid and the main grid when the first charging target is the first individual ESS.

4. The apparatus of claim 1, wherein the instructions of the processor further comprise:
providing an individual power supplier list to the first user terminal based on an individual power purchase request of the first user terminal, and
supplying individual power of a first individual power supplier to the first charging target through at least one of electric vehicle supply equipment (EVSE), the microgrid, or the main grid when the first user terminal selects the first individual power supplier included in the individual power supplier list.

5. The apparatus of claim 1, wherein the power purchase request received from the first user terminal is a request for charging at least one of a first electric vehicle or a first individual ESS associated with a user of the first user terminal.

6. The apparatus of claim 1, wherein the instructions of the processor further comprise:
when an emergency situation requesting a power supply to a second charging target occurs, supplying the individual power to the second charging target through at least one of the microgrid and a main grid,
the public power is power stored in a public ESS managed by the microgrid, and
the individual power is power stored in at least one of a third electric vehicle or a third individual ESS associated with one of a plurality of third user terminals.

7. The apparatus of claim 6, wherein the instructions of the processor further comprise:
when the emergency situation occurs, generating a message to induce a sale of the individual power and transmitting the generated message to the plurality of third user terminals.

8. The apparatus of claim 7, wherein the instructions of the processor further comprise:
informing the plurality of third user terminals of a purchase price when the microgrid purchases the individual power and a purchase price when the main grid purchases the individual power,
storing individual power in at least one of the third electric vehicle or the third individual ESS to be supplied to the public ESS after billing processing when an emergency power sale to the microgrid is accepted from one of the plurality of third user terminals, and
supplying the individual power to the public ESS to be supplied to the second charging target.

9. The apparatus of claim 8, wherein the second charging target includes at least one of a fourth individual ESS associated with a user of a fourth user terminal or an external public ESS used in an external microgrid, and
supplying the individual power to the second charging target through at least one of electric vehicle supply equipment (EVSE), the microgrid, or the main grid.

10. The apparatus of claim 6, wherein the instructions of the processor further comprise:
providing an individual power consumer list to the plurality of third user terminals; and
supplying the individual power stored in at least one of the third electric vehicle or the third individual ESS to an electric vehicle or an individual ESS of a first individual power consumer after billing processing when one of the plurality of third user terminals selects the first individual power consumer included in the individual power consumer list.

11. A method of supporting power trading of an apparatus including a memory storing computer-executable instructions, and at least one processor configured to access the memory and execute the instructions, the method comprising:
receiving a power purchase request from a first user terminal; and
supplying at least one of public power or individual power to a first charging target designated by the first user terminal through a microgrid.

12. The method of claim 11, wherein
the public power is power stored in a public energy storage system (ESS) managed by the microgrid, and
the individual power is power stored in at least one of a second electric vehicle or a second individual ESS associated with a user of a second user terminal.

13. The method of claim 12, wherein supplying at least one of the public power or the individual power to the first charging target includes:
informing the first user terminal of a sales price of the public power sold in the microgrid and a sales price of main power sold in a main grid when the power purchase request is received; and
supplying the public power stored in the public ESS to the first charging target after billing processing when the first user terminal selects the public power.

14. The method of claim 13, wherein supplying at least one of the public power or the individual power to the first charging target includes:
supplying the public power to a first electric vehicle through electric vehicle supply equipment (EVSE) and the microgrid when the first charging target is the first electric vehicle; and
supplying the public power to a first individual ESS through at least one of the microgrid and the main grid when the first charging target is the first individual ESS.

15. The method of claim 11, wherein supplying at least one of the public power or the individual power to the first charging target includes:
providing an individual power supplier list to the first user terminal based on an individual power purchase request of the first user terminal; and
supplying individual power of a first individual power supplier to the first charging target through at least one of electric vehicle supply equipment (EVSE), the microgrid, or the main grid when the first user terminal selects the first individual power supplier included in the individual power supplier list.

16. The method of claim 11, wherein the power purchase request received from the first user terminal is a request for charging at least one of a first electric vehicle and a first individual ESS associated with a user of the first user terminal.

17. The method of claim 11, further comprising:
supplying the individual power to a second charging target through at least one of the microgrid or a main grid when an emergency situation requesting a power supply to the second charging target occurs, wherein the public power is power stored in a public ESS managed by the microgrid, and
the individual power is power stored in at least one of a third electric vehicle and a third individual ESS associated with one of a plurality of third user terminals;
generating a message to induce a sale of the individual power; and
transmitting the generated message to the plurality of third user terminals when the emergency situation occurs.

18. The method of claim 17, wherein supplying the individual power to the second charging target includes:
informing a plurality of second user terminals of a purchase price when the microgrid purchases the individual power and a purchase price when the main grid purchases the individual power;
supplying the individual power stored in at least one of the third electric vehicle or the third individual ESS to the public ESS after billing processing when an emergency power sale to the microgrid is accepted from one of the plurality of third user terminals; and
supplying the individual power supplied to the public ESS to the second charging target.

19. The method of claim 18, wherein the second charging target includes at least one of a fourth individual ESS associated with a user of a fourth user terminal or an external public ESS used in an external microgrid, and
supplying the individual power to the second charging target includes supplying the individual power to the second charging target through at least one of electric vehicle supply equipment (EVSE), the microgrid, or the main grid.

20. The method of claim 18, wherein supplying the individual power to the second charging target includes:
providing an individual power consumer list to the plurality of third user terminals; and
processing the individual power to be traded between at least one of the plurality of third user terminals or a first individual power consumer after the billing processing when at least one of the plurality of third user terminals selects the first individual power consumer included in the individual power consumer list.
